(19) United States
(12) Patent Application Publication
(10) Pub. No.: US 2012/0099725 A1
(43) Pub. Date: Apr. 26, 2012

(54) METHOD OF GENERATING ID WITH GUARANTEED VALIDITY, AND VALIDITY LEGITIMACY GUARANTYING RFID TAG

(75) Inventors: Hisao Sakazaki, Yokohama (JP); Keisuke Hakuta, Sagamihara (JP); Hidehiko Kando, Yokohama (JP)

(73) Assignee: HITACHI, LTD., Tokyo (JP)

(21) Appl. No.: 13/203,967

(22) PCT Filed: May 10, 2010
(86) PCT No.: PCT/JP2010/003173

§ 371 Date: Dec. 20, 2011

(30) Foreign Application Priority Data
Jun. 1, 2009 (JP) 2009-131708

(51) Int. Cl. H04L 9/28

(52) U.S. Cl. 380/28

(57) ABSTRACT

A portion of a digital signature value for authenticating the validity of ID information is also used as an ID so as to reduce the amount of data. This is achieved by using a digital signature scheme with a short signature length obtained by transforming a Schnorr signature, which is a typical example of a digital signature scheme.

### FIELD OF THE INVENTION

The present invention relates to technique for guarantying the validity of ID information, the generation and the authentication of a digital signature.

### BACKGROUND OF THE INVENTION

RFID (Radio Frequency IDentification) denotes exchanging information by radio communication in a close range using a radio wave and others with a tag including ID information and is utilized in various fields such as a field of the physical distribution management and the traceability of food and commodities, an IC ticket of a means of transportation and an employee's or a student's identification card.

The utilization of RFID for security such as using for discriminating a forgery and a fake is also expected by installing an RFID tag on a proper article. When RFID is used for security as described above, a mechanism for discriminating whether or not the RFID tag itself is an RFID tag manufactured by a proper RFID tag manufacturer is desired.

For conventional type technique for guarantying the validity of ID information included in an RFID tag, a method of listing all ID information in RFID tags issued by a proper RFID tag manufacturer and verifying whether or not corresponding ID information is the issued ID information online (Patent Document 1) and a method of verifying whether or not corresponding ID information is valid ID information using a MAC (Message Authentication Code) and digital signature technique (Patent Document 2) can be given.

### Prior Art Documents

### Patent Documents

Patent document 1: JP-A No. 2002-140404
Patent document 2: JP-A No. 2002-024767

### SUMMARY OF THE INVENTION

### Problem to be Solved by the Invention

In the method of verifying the list online which is one of the conventional type ID information guarantying technique, as frequencies in which an RFID tag is authenticated increase, a load onto a network increases, and the method is unsuitable for large scale packaging. Besides, in the method using the MAC, offline verification is possible and a problem such as a load onto the network in the large scale packaging can be settled. In that case, however, it is required to let an RFID reader have a private key for authentication. The key is common in the whole system and once the key is leaked, the security of the whole system is deteriorated.

Therefore, a mechanism for authenticating the validity of ID information offline without letting the side that authenticates ID information such as an RFID reader have confidential information is desired. Generally, when a digital signature by a public key is applied, the above-mentioned problem can be settled. However, as to a signature according to RSA normally used, when security is considered, 1024 bits or more are required as a signature length and the signature according to RSA cannot be packaged in a small-sized RFID tag that can transmit only the information of a few hundred bits for example.

Therefore, it is demanded that the validity of ID information should be guaranteed offline without letting the side of the RFID reader have confidential information and the validity of ID information should also be guaranteed by the RFID tag that can transmit only the information of a few hundred bits.

### Means for Solving the Problem

In the present invention, the validity of ID information is authenticated offline by an RFID tag that can transmit only the information of a few hundred bits without letting the side that authenticates such as an RFID reader have confidential information and the validity of the ID information is guaranteed.

Concretely, the present invention also utilizes a portion of information for authenticating the validity of ID information (hereinafter also called an authenticated value or a signature value if necessary) as ID information. Hereby, an RFID tag provided with ID information and information for guarantying the validity of the ID information is achieved in spite of a small amount of information volume as a whole.

### Effect of the Invention

According to the present invention, the data size of the RFID tag can be reduced by also utilizing a portion of a signature value as ID. Thereby, a system for guarantying the validity of ID information according to a digital signature scheme even using a small-sized RFID tag that can transmit only the data of a few hundred bits can be provided.

### BRIEF DESCRIPTION OF THE DRAWINGS

FIG. 1 is a whole block diagram in one embodiment;

FIG. 2 shows an example of the hardware configuration of an ID issuing device, an authenticating device and an application program;

FIG. 3 shows the contents of data in an RFID tag;

FIG. 4 shows parameters managed by the ID issuing device, a signing method using the parameters, parameters managed by the authenticating device and an authenticating method using the parameters;

FIG. 5 shows a work flow for explaining a process related to the generation of ID and a signature in one embodiment; and

FIG. 6 shows a work flow for explaining a process related to the authentication of the signature in one embodiment.

### DETAILED DESCRIPTION OF THE PREFERRED EMBODIMENTS

Referring to the drawings, one embodiment of the present invention will be described below. However, the present invention is not limited by this embodiment.

### First Embodiment

First, an outline of this embodiment will be described.

In this embodiment, a portion of information for authenticating the validity of ID information, that is, an authenticated value or a signature value is also utilized as ID so as to guarantee the validity of the ID information with a small amount of information volume. In this embodiment, a Schnore signature which is a typical example of a digital signature scheme is used to guarantee the validity with less information volume. A digital signature scheme with a short signature length can be achieved by transforming the Schnore signature using residue number arithmetic.

Further, a scheme in which ID information and others are uniquely assigned is adopted. Concretely, the ID issuing device sets each parameter used for the signature scheme and calculates a digital signature according to the present invention for a specific message. The ID issuing device writes a portion of a signature value to an ID information area of an RFID tag as an ID and writes a portion of the rest to a control information area.

Further, the ID issuing device opens public information including a public key to each authenticating device and each authenticating device authenticates ID information from the ID information area of the RFID tag and information for authentication from the control information area using the public key.

The ID issuing device compares ID with data issued in the past to prevent the same ID and others from existing when the ID issuing device generates ID and others which are also an authenticated value and secures the uniqueness of the ID.

The ID issuing device generates the corresponding ID based upon a serial number so as to enable managing the generated ID according to the serial number. Further, when it is necessary to secure the uniqueness of control information, the ID issuing device compares the control information with data issued in the past and secures the uniqueness of the control information.

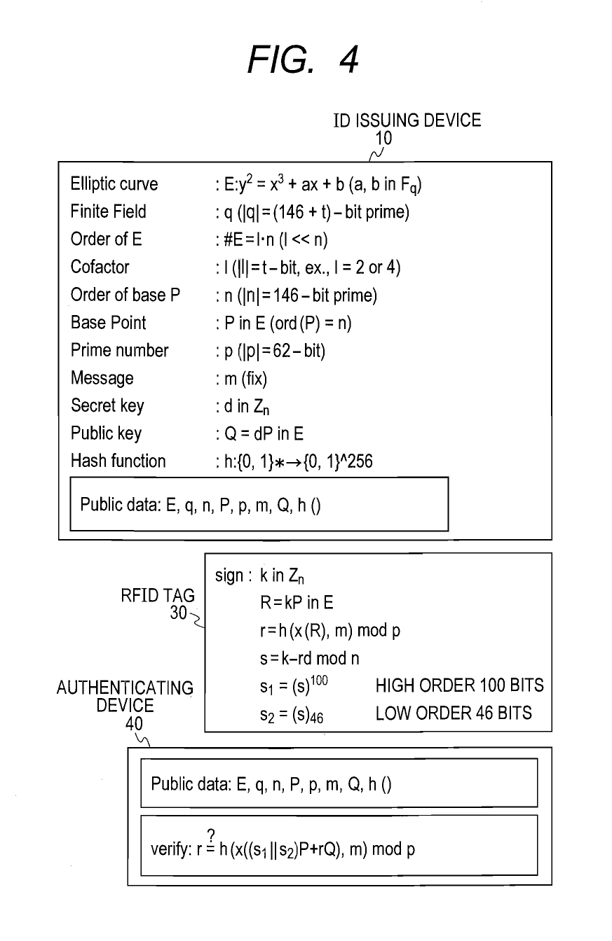

Further, a value of r is reduced by the arithmetic operation of the r which is one of signature values as shown in FIG. 4 modulo a specific value p when the Schnore signature is calculated on an elliptic curve.

Further, s which is another signature value is divided in accordance with the capacity of the RFID tag.

The details of this embodiment will be described below.

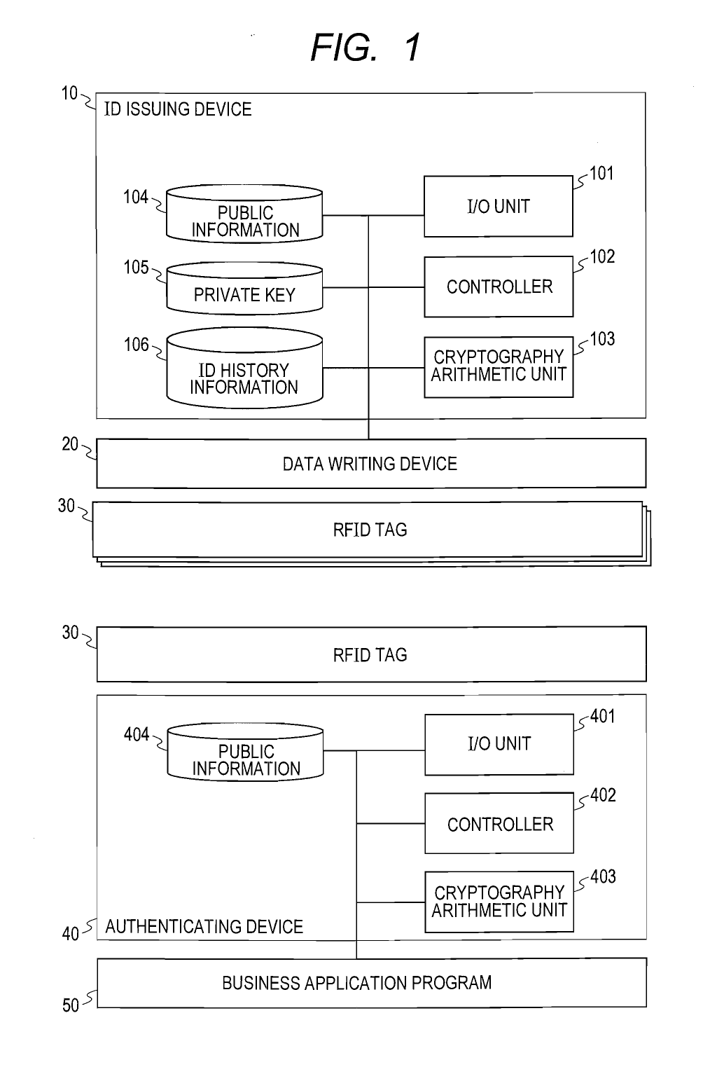

FIG. 1 is a whole block diagram to which one embodiment of the present invention is applied.

An ID issuing device 10 first selects a prime number q of (146+t) bits as shown in FIG. 4. The ID issuing device further selects coefficients a and b of the elliptic curve from a finite field Fq and sets the elliptic curve E. At this time, the order #E of the elliptic curve is set to 1·n(1<<n) and a base point P is selected from the elliptic curve E to be order n. In addition, a prime number p of 62 bits and a message m are also selected. “d” is selected in Zn to be a private key of the ID issuing device 10. Besides, a point Q (=dP) on the elliptic curve E is calculated to be the public key of the ID issuing device 10. Further, h( ) is set as a hash function for converting data of arbitrary length to fixed length and has the length of 256 bits. The ID issuing device 10 that sets these values opens E, q, n, P, p, m, Q, h( ) as public information.

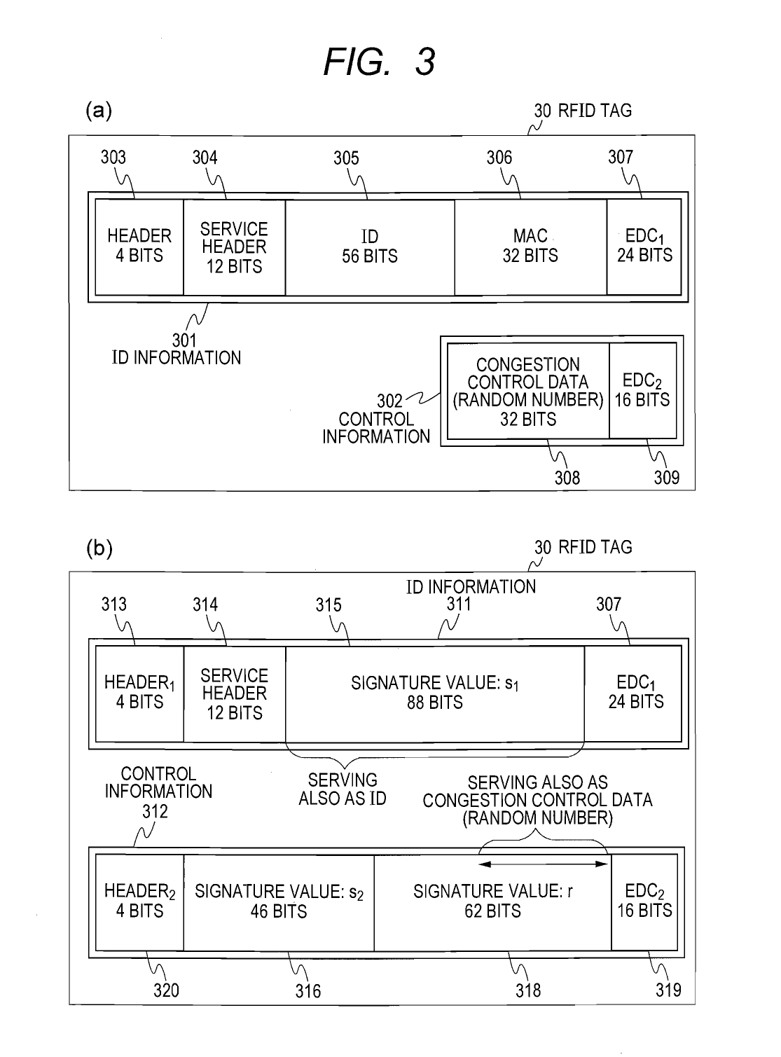

The ID issuing device 10 includes the public information 104, the private key 105, ID history information 106 storing ID information and control information respectively generated in the past, an I/O unit 101 that inputs and outputs data, a cryptography arithmetic unit 103 that generates a digital signature and a controller 102 that controls them, generates a signature value for authentication using the parameter, and assigns it to ID information 311 and control information 320 respectively shown in FIG. 3. Further, the ID issuing device 10 generates as many pieces of the ID information 311 and the control information 320 respectively including the signature value as required and lists them. The ID issuing device transmits the list to a data writing device 20.

The data writing device 20 is a device for writing required information to a medium and writes, to the RFID tag 30, the ID information 311 and the control information 320 from the list transmitted from the ID issuing device 10.

The RFID tag 30 is a medium to which the ID information 311 and the control information 320 are written and transmits the ID information 311 and the control information 320 to an authenticating device 40 according to a request of the authenticating device 40.

The authenticating device 40 includes public information 404 in which public information set by the ID issuing device 10 is stored, an I/O unit 401 that inputs and outputs data, a cryptography arithmetic unit 403 that authenticates a digital signature and a controller 402 that controls them, reads ID information and an authenticated value from the RFID tag 30, and verifies whether or not the corresponding ID is valid ID generated by the ID issuing device 10 using the public information set by the ID issuing device 10. When the authentication succeeds, the authenticating device delivers the corresponding ID information to a business application program 50. The business application program 50 requests or receives an ID, executes service based upon the received ID, and executes service for the ID delivered from the authenticating device 40 if necessary.

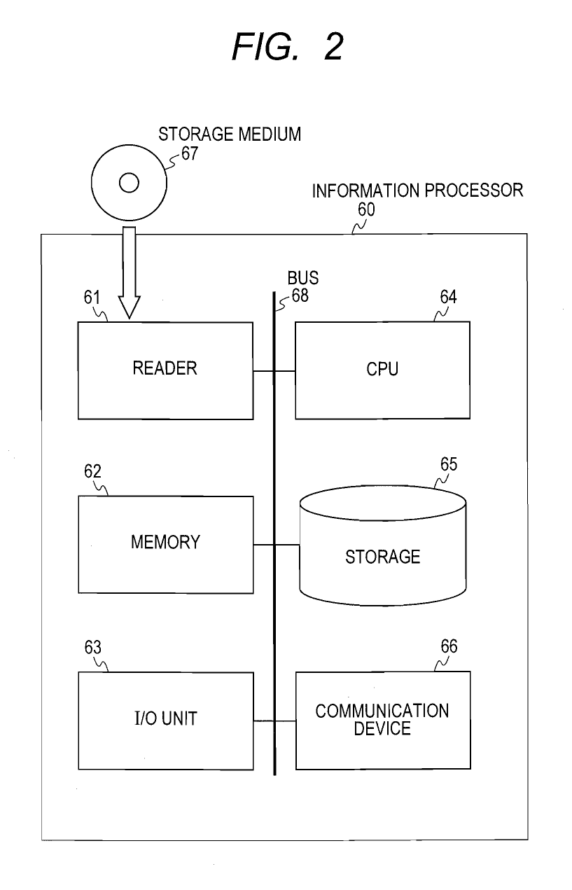

Further, the ID issuing device 10 and the authenticating device 40 can be respectively configured as an information processor 60 in which a storage medium 67, a reader 61 of the storage medium 67, a primary storage (hereinafter called a memory) 62 using a semiconductor device, an I/O unit 63, a CPU 64, a secondary storage (hereinafter called a storage) 65 such as a hard disk and a communication device 66 are connected via an internal communication line (hereinafter called a bus) 68 such as a bus as shown in FIG. 2.

The cryptography arithmetic units 103, 403, the public information 104, 404, the private key 105, 405, the ID history information 106 and the controllers 102, 402 respectively described above are implemented in the processors when each CPU 64 executes programs stored in the memories 62 or in the storages 65 of the respective processors. Further, these programs, the public information 104, 404, the private key 105, 405 and the ID history information 106 may also be stored in the storages 65, may also be installed in the information processors 60 via the detachable storage medium 67 if necessary and may also be installed from an external device via the communication device 66.

RFID denotes exchanging information stored in the RFID tag by radio communication in a close range using an electromagnetic field, a radio wave and others and in this embodiment, written ID information is set to 128 bits. However, the size of each data such as an authenticated value and public information including ID information is one example and the present invention is not limited by this.

FIG. 3(a) shows one example of a data format for explaining a conventional type scheme using MAC. The RFID tag 30 includes ID information 301 of 128 bits and control information 302 of 48 bits used for congestion control. The ID information 301 is configured by a header 1303, a service header 304, an ID 305, a MAC 306 and an EDC1 (Error Detecting Code) 307. A field of the header 1-303 includes information for identifying version information and others and a field of the service header 304 includes information for identifying application and others. The ID 305 is a real purpose of the RFID tag 30. The MAC 306 is a falsification detecting code (an MAC value) for the header 303, the service header 304 and the ID 305. The EDC1 307 is an error detecting code for the header 303, the service header 304, the ID 305 and the MAC 306. In the meantime, the control information 302 includes data (a random number) for congestion control 308 and EDC2-309, and the EDC2-309 is an error detecting code for the data (the random number) for congestion control 308. The data (the random number) for congestion control 308 is a random number for determining order in congestion control.

In the present invention, in place of the ID 305, a signature value 315 is also used for ID. The validity of ID is verified using signature values 315, 318, 321 in place of the MAC 306. A field of a header 1-313 includes information for identifying version information and others and a field of a service header 314 includes information for identifying application and others. EDC1-317 is an error detecting code for the header 1-313, the service header 314 and the signature value that also services as ID 315. A field of a header 2-320 includes information showing a version number, data length and others, and EDC 2-319 is an error detecting code for the header 2-320, the signature values 318, 321 (see FIG. 3(b)).

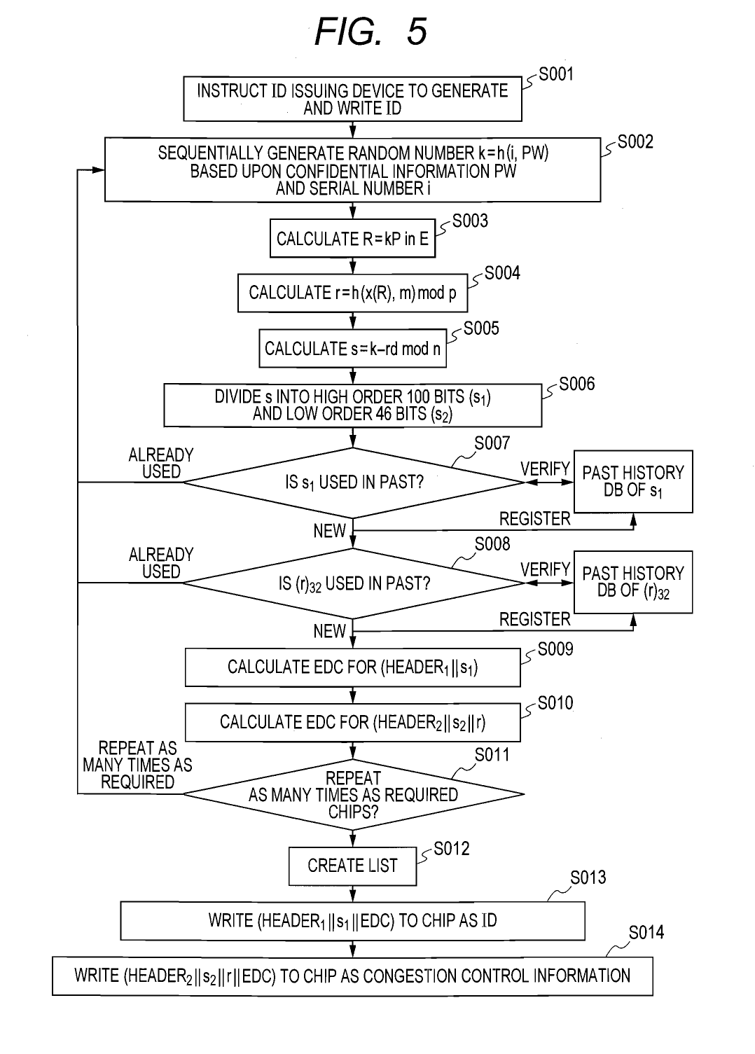

Next, a method of generating ID and a signature value will be described referring to FIG. 5. The ID issuing device 10 is to have already set each parameter described above (see FIG. 4). As for a notation, a lowercase letter of an alphabet denotes a numeric value and an uppercase letter denotes a point on an elliptic curve.

The ID issuing device 10 that receives an instruction to generate and write ID generates a random number k in the cryptography arithmetic unit 103 (S001, S002). At that time, the ID issuing device 10 sets its own confidential information (hereinafter called PW), sets an output value of a hash function h( ) using the PW and a serial number for input as the random number k, and sequentially generates random numbers. The PW may also be stored and managed in a field of the private key 105 if necessary.

The ID issuing device 10 calculates a point R (=kP) on the elliptic curve (S003), operates a residue of an output value of the hash function h( ) using x (R) which are the x coordinates of the point R and a message m for input modulo p, and sets the value as r which is one of signature values (S004). “x ( )” denotes the x coordinates of a point on the elliptic curve.

The ID issuing device 10 calculates s=k−rd mod n which is another signature value (S005).

The ID issuing device 10 divides s into s1 of high order 100 bits and s2 of low order 46 bits so as to use a portion of the signature value for ID (S006). (High order n bits of a certain value x and low order m bits are also expressed (x) ̂n and (x) m) as s1=(s) ̂100 and s2=(s) 46.) As the s1 is also handled as ID, it is verified by comparing the s1 with the ID history information 106 whether the s1 is a value used in the past or not so as to avoid duplication (S007), if the s1 is already used in the past, control is returned to S002, a serial number i is updated, and the operation is repeated until unused s1 is generated.

When new s1 is generated, the controller of the ID issuing device 10 updates the ID history information 106. Further, as low order 32 bits of the signature value r are also handled as data for congestion control, it is similarly verified by comparing the 32 bits with the ID history information 106 whether 32 bits of the r are a value used in the past or not so as to avoid duplication (S008), if they are already used in the past, control is returned to S002, the serial number i is updated, and the operation is repeated until unused 32 bits of r are generated.

When new 32 bits of r are generated, the ID history information 106 is updated. Further, the header1 313 which is header information used for identifying a version and the service header 1-313 for identifying application are generated and the EDC1 317 which is a simple error detecting code for a value in which the header 1-313, the service header 314 and the s1-315 are combined is calculated (S009). Further, the header 2-320 for identifying version information is generated and the EDC 2-319 which is a simple error detecting code for a value in which the header 2-320, the s2-316 and the r 318 are combined is calculated (S010).

The ID issuing device 10 returns control to S002 if necessary and generates as many sets of values generated in S009 and S010 as required chips (S011).

When the sets of values generated in S009 and S010 are prepared by the required number, the sets of values are all listed (S012), they are delivered to the data writing device 20, and the data writing device 20 writes (header1∥service header∥s1∥EDC1) to each RFID tag 30 as shown in FIG. 3B as the ID information 311 and writes (header2∥s2∥r∥EDC2) to the RFID tag 30 as the control information 312 (S013, S014) respectively based upon the list.

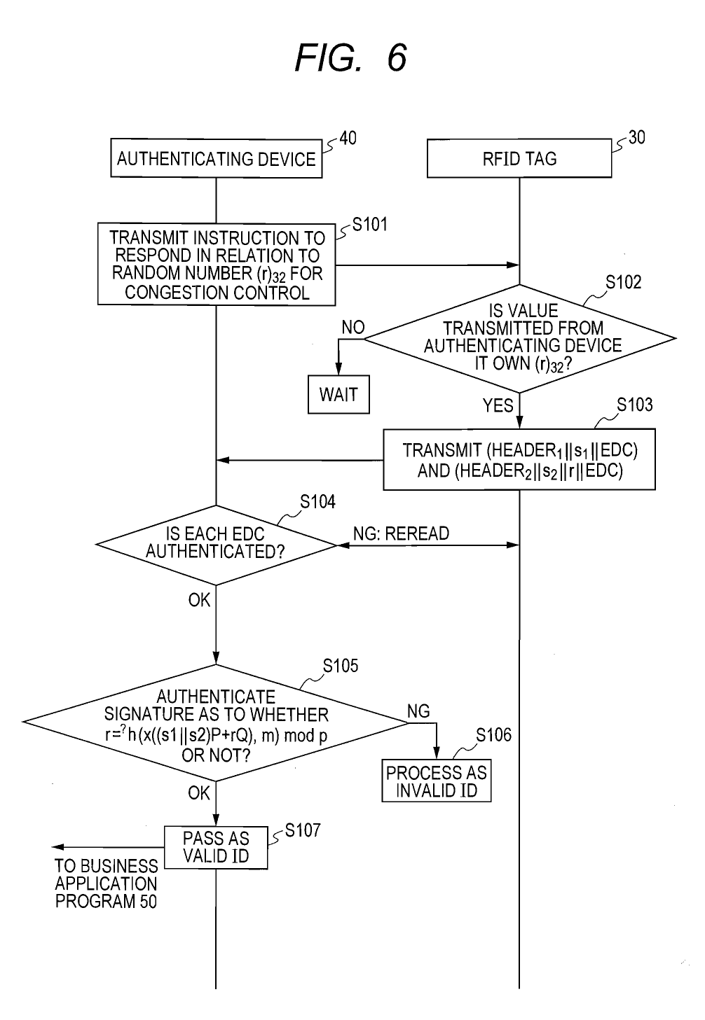

Next, a method of verifying the validity of the RFID tag 30 will be described referring to FIG. 6.

The authenticating device 40 transmits numeric values for 32 bits to the RFID tag 30 in the vicinity in descending order and issues an instruction to respond (S101).

The RFID tag 30 verifies whether the values transmitted from the authenticating device 40 are its own 32 bits of the r or not (S102) and transmits ID information (header1∥service header∥s1∥EDC1) 311 and control information (header2∥s2∥r∥EDC2) 312 to the authenticating device 40 in response to the instruction to respond in S101 if the numeric values are its own ones (S103).

The authenticating device 40 verifies an error detecting code EDC1 for header1∥service header∥s1 based upon the ID information (header1∥service header∥s1∥EDC1) 311 and verifies an error detecting code EDC2 for header2∥s2∥r based upon the control information (header2∥s2∥r∥EDC2) 312 (S104). When an error is detected, rereading is performed by a set frequency and when errors are caused in spite of it, the situation is handled as a read error.

When reading succeeds in S104, a signature is authenticated as whether r=h(x((s1∥s2)P+rQ), m)mod p or not (S105).

When the authentication fails in S105, the corresponding ID is handled as invalid ID (S106) and when the authentication succeeds, necessary information such as the ID information 311 is delivered to the business application program 50 as a valid ID (S107).

As described above, according to this embodiment, the RFID tag 30 can verify the validity of ID using the s1 315 which is a portion of the authenticated value for ID and using the authenticated values the s1-315, the s2-316 and the r318.

Besides, the total information volume of the ID information 311 and the control information 312 is 256 bits and can also be stored in the small-sized RFID tag that can transmit only information of a few hundred bits.

In addition, as the authenticating device 40 manages only the public information 404 and no private key 105 is given to the device, a risk that the private key 105 is directly leaked from the authenticating device 40 can be avoided.

Further, the authenticating device 40 can locally verify the validity of ID by only authenticating a digital signature according to this scheme without connecting to a network and others.

That is, according to this embodiment, a system that the validity of ID information is guaranteed offline without giving the private key 105 to the authenticating device 40 and the validity of the ID information is also guaranteed in the small-sized RFID tag that can transmit only information of a few hundred bits can be provided.

The present invention is not limited to this embodiment and various embodiments are allowed in a range of the object.

For example, in FIG. 3(b), the ID information 311 and the control information 312 are shown as discontinuous data and the header and the EDC are assigned to each data. However, the ID information 311 and the control information 312 are handled as continuous data and only one header and EDC may also be assigned.

Further, although in S007 and S008 in FIG. 5, the s1 and 32 bits of the r are compared with the past history so as to avoid duplication, when the uniqueness of ID and the uniqueness of a random number for congestion control are not required, these steps may also be skipped if necessary. In addition, in the RFID tag 30 in which data (a random number) for congestion control is separately prepared, the signature value 318 is not required to also function as data (a random number) for congestion control. Further, it is described in this embodiment that the random number for congestion control is a partial value of the signature value 318. However, the random number for congestion control may also be the whole signature value 318 or may also include the whole signature value 318.

Further, the signature value 315 that also functions as ID is a partial value of the signature value s, though the signature value 315 may also be the whole signature value s.

Further, S101 and S102 are steps for congestion control and when congestion control is not required, these steps may also be skipped.

Further, in FIG. 6, the authenticating device 40 transmits numeric values for 32 bits to the RFID tag 30 in the vicinity in descending order for congestion control and issues an instruction to respond. However, the authenticating device may also transmit values for 32 bits showing order to the RFID tag 30 in ascending order and at random and may also issue an instruction to respond. In addition, a value for 32 bits of data (a random number) for congestion control on the side of the RFID tag 30 is divided in four pieces by 8 bits for example, the authenticating device 40 transmits the data of 8 bits to the RFID tag 30 in ascending order, in descending order or at random, the RFID tag 30 judges whether first 8 bits in the data (the random number) for congestion control divided in four by 8 bits are coincident with a value transmitted from the authenticating device 40 or not, and may also respond. At that time, when plural RFID tags 30 having the same number as to the first 8 bits exist, the authenticating device 40 transmits data of 8 bits to the RFID tag 30 in ascending order, in descending order or at random again, the RFID tag 30 judges whether the next 8 bits in the data (the random number) for congestion control divided in four by 8 bits are coincident with a value transmitted from the authenticating device 40 or not and responds, and when the same number still exists, congestion control may also be made by similarly repeating the operation as to the next 8 bits and the further next 8 bits.

Further, although in FIG. 6, the authenticating device 40 transmits required information to the business application program 50 when the validity of ID can be verified in S107, when the authentication by EDC passes in S104, the authenticating device transmits required information to the business application program 50, then the authenticating device 40 authenticates a signature, and may also transmit a result of the authentication to the business application program 50 again.

Further, in this embodiment, the Schnorr signature is transformed on the elliptic curve, though it may also be transformed on the other algebraic number field.

Further, this embodiment is described using the RFID tag for an example. However, the other device such as a medium printed on paper and others like a two-dimensional bar code, an IC card and normal PC may also be used.

### DESCRIPTION OF REFERENCE NUMERALS

10: ID issuing device, 20: Data writing device, 30: RFID tag, 40: Authenticating device, 50: Business application program, 60: Information processor, 61: Reader, 62: Memory, 63: I/O unit, 64: CPU, 65: Storage, 66: Communication device, 67: Storage medium, 68: Bus, 101, 401: I/O unit, 102, 402: Controller, 103, 403: Cryptography arithmetic unit, 104, 404: Public information, 105: Private key, 106: ID history information, 301, 311: ID information, 302, 312: Control information, 303, 313, 320: Header, 304, 314: Service header, 305: ID, 306: MAC, 307, 309, 317, 319: EDC, 308: Data (Random number) for congestion control, 315, 318, 321: Signature value.

1. An ID generating method of generating an ID with guaranteed validity, comprising the steps of:
generating a random number by a cryptography arithmetic unit and generating a signature value from the generated random number;
dividing the generated signature value;
verifying whether or not the same data as one signature value out of the divided signature values exists in an ID history information database; and
storing the one signature value in an RFID tag as ID of the RFID tag by a data writing device when no same data exists in the ID history information database.

2. The ID generating method according to claim 1, further comprising the step of:
writing the one signature value to the ID history information database by a controller when no same data exists in the ID history information database.

3. The ID generating method according to claim 2,
wherein in the step of dividing the signature value by the cryptography arithmetic unit, authenticated information is divided according to the capacity of data or application.

4. The ID generating method according to claim 3,
wherein in the step of generating the signature value, a Schnorr signature is used.

5. The ID generating method according to claim 1,
wherein the other signature value which is not one signature value of the divided signature values is written to the RFID tag as information for congestion control.

6. An RFID tag, comprising an ID generated by the ID generating method according to claim 1.

7. An RFID tag provided with an ID generated by the ID generating method according to claim 5, comprising:
an I/O unit that receives an instruction to respond including a random number for congestion control from en external device and transmits a signal in response to the instruction to respond; and
a processing unit that compares the random number for congestion control received by the I/O unit with the information for congestion control in the RFID tag and instructs the I/O unit to output one signature value of the divided signature values and the random number for congestion control as a signal in response to the instruction to respond when the corresponding information is the same.

8. An RFID tag reading method of reading an ID in an RFID tag provided with an ID generated by the ID generating method according to claim 5, comprising the steps of:
transmitting an instruction to respond including a random number of congestion control from an authenticating device to the RFID tag;
comparing the random number for congestion control from the authenticating device with the information for congestion control in the RFID tag and transmitting one signature value of the divided signature values and the random number for congestion control from the RFID tag to the authenticating device as a response signal in response to the instruction to respond; and
authenticating a signature based upon the response signal,
wherein when it is verified that the signature is a valid signature as a result of authenticating the signature, the response signal is read as a valid ID.

9. The RFID tag reading method according to claim 8,
wherein in the step of authenticating the signature based upon the response signal, the signature is authenticated in a state in which one signature value of the divided signature values and the random number for congestion control are combined.

10. The RFID tag reading method according to claim 8,
wherein in the step of authenticating the signature, the signature is authenticated based upon the response signal and public information stored in the authenticating device.

11. The RFID tag reading method according to claim 8,
wherein an error detecting code EDC is appended to the response signal.
